(19) United States
(12) Patent Application Publication
(10) Pub. No.: US 2024/0089901 A1
(43) Pub. Date: Mar. 14, 2024

(54) COMMUNICATION METHOD FOR EXECUTING PERCEPTION TASK AND COMMUNICATION APPARATUS

(71) Applicant: HUAWEI TECHNOLOGIES CO., LTD., Shenzhen (CN)

(72) Inventors: Zhe LIU, Shanghai (CN); Chenghui PENG, Shanghai (CN); Jianjun WU, Shenzhen (CN)

(21) Appl. No.: 18/514,079

(22) Filed: Nov. 20, 2023

Related U.S. Application Data
(63) Continuation of application No. PCT/CN2022/082842, filed on Mar. 24, 2022.

(30) Foreign Application Priority Data
May 21, 2021 (CN) 202110559357.3

(51) Int. Cl. H04W 64/00; H04W 8/22; H04W 68/02; H04W 76/10

(52) U.S. Cl. CPC H04W 64/00; H04W 8/22; H04W 68/02; H04W 76/10

(57) ABSTRACT

A communication method includes receiving, by a core network functional entity, request information of a perception task from a task trigger source. The request information includes first area range information. The first area range information indicates to execute the perception task within a first area range. The communication method also includes sending, by the core network functional entity, first configuration information of the perception task to an access network device. The first configuration information includes an identifier of a communication device and second area range information. The second area range information indicates to execute the perception task within a second area range. The second area range is a subset of the first area range.

### CROSS-REFERENCE TO RELATED APPLICATIONS

This application continuation of International Application No. PCT/CN2022/082842, filed on Mar. 24, 2022, which claims priority to Chinese Patent Application No. 202110559357.3, filed on May 21, 2021. The disclosures of the aforementioned applications are hereby incorporated by reference in their entireties.

### TECHNICAL FIELD

This application relates to the field of wireless network technologies, and in particular, to a communication method for executing a perception task and a communication apparatus.

### BACKGROUND

A communication network developed based on a conventional voice service, for example, a 5th generation (5G) network, is in a connection-oriented single communication mode, and cannot execute a perception task.

### SUMMARY

This application provides a communication method and a communication apparatus, to execute a perception task.

According to a first aspect, this application provides a communication method for executing a perception task. The method includes: A core network functional entity receives request information of a perception task from a task trigger source. The request information includes first area range information, and the first area range information indicates to execute the perception task within a first area range. The core network functional entity sends first configuration information of the perception task to an access network device. The first configuration information includes an identifier of a communication device and second area range information, the second area range information indicates to execute the perception task within a second area range, and the second area range is a subset of the first area range.

According to the communication method in this application, the core network functional entity receives the request information of the perception task sent from the task trigger source, and sends configuration information of the perception task to the access network device based on the request information of the perception task, so that the access network device may send the configuration information of the perception task to a terminal device, and the terminal device may complete the perception task based on the configuration information of the perception task, to finally implement a “connection+ perception”-oriented communication mode.

In addition, the core network functional entity receives the request information of the perception task and sends the configuration information of the perception task to the access network device. In comparison with that a network functional entity other than a core network receives the request information of the perception task and sends the configuration information of the perception task to the access network device, a procedure of delivering the perception task needs to pass through an access network and the core network instead of a data network. Therefore, a latency of delivering the perception task can be reduced, and finally, a latency of implementing the perception task can be reduced.

In addition, the second area range is a subset of the first area range. In some embodiments, the second area range is within the first area range. Therefore, execution of the perception task by the terminal device in an area beyond the first area range can be avoided, to avoid a waste of resources of the terminal device.

Optionally, the second area range may be a proper subset of the first area range. In some embodiments, the second area range may be a part of the first area range. In this implementation, because the second area range is smaller than the first area range, the terminal device can efficiently complete the perception task.

In some possible implementations, the communication device includes the access network device.

In this implementation, that the communication device includes the access network device may be understood as that the core network functional entity performs access network device-level division on the perception task. In comparison with that the core network functional entity performs only terminal device-level division on the perception task, because the access network device can learn of a current connection status of the terminal device, the access network device can preferentially select a terminal device in a connected mode to execute the perception task. In comparison with that the access network device selects a terminal device in a non-connected mode, the access network device preferentially selects the terminal device in the connected mode. This can reduce a latency caused by paging the terminal device.

In some possible implementations, the communication device includes an identifier of the terminal device. That the communication device includes an identifier of the terminal device may be understood as that the core network functional entity performs terminal device-level division on the perception task. In comparison with an implementation in which the access network device participates in division of the perception task, this can reduce complexity of the access network device.

In some possible implementations, when the communication device includes the terminal device, the method further includes: The core network functional entity obtains one or more of mobility information, task subscription information, and perception capability information of the terminal device. That the core network functional entity sends first configuration information of the perception task to an access network device includes: The core network functional entity sends the identifier of the terminal device and the second area range information based on the one or more information to the access network device.

In this implementation, the core network functional entity sends, to the access network device based on the mobility information of the terminal device, the first configuration information that includes the identifier of the terminal device and the second area range information. This helps the core network functional entity select a terminal device within the first area range to execute the perception task. In some embodiments, this helps the core network functional entity avoid selecting a terminal device beyond the first area range, to improve execution efficiency of the perception task.

The core network functional entity sends, to the access network device based on the perception capability information of the terminal device, the first configuration information that includes the identifier of the terminal device and the second area range information. This helps the core network functional entity select a terminal device that has a corresponding perception capability to execute the perception task. In some embodiments, this helps the core network functional entity avoid selecting a terminal device without a corresponding perception capability, to improve execution efficiency of the perception task.

The core network functional entity sends, to the access network device based on the task subscription information of the terminal device, the first configuration information that includes the identifier of the terminal device and the second area range information. This helps the core network functional entity select a terminal device that subscribes to the perception task to execute the perception task. In some embodiments, this helps the core network functional entity avoid selecting a terminal device that does not subscribe to the perception task, to improve execution efficiency of the perception task.

In some possible implementations, the request information further includes a type of the perception task, and the type includes one or more of the following types: terahertz imaging perception, camera visual perception, channel state information perception, or location perception.

In this implementation, the request information includes the type of the perception task. This helps the core network device or the access network device accurately determine a terminal device that has a corresponding perception capability to execute the perception task when the core network device or the access network device determines a terminal device that is to execute the perception task.

When the communication device includes the terminal device, in some possible implementations, the method further includes: The core network functional entity determines whether the terminal device is in an idle mode. When the terminal device is in the idle mode, the core network functional entity sends a paging message to the terminal device.

A core network functional device first determines whether the terminal device is in the idle mode, and sends the paging message to the terminal device in the idle mode, so that an RRC connection is established between the terminal device and the access network device. In this way, even if the core network functional entity selects the terminal device in the idle mode to execute the perception task, it can be ensured that the terminal device can enter the connected mode to receive second configuration information of the perception task, to execute the perception task, so as to improve execution efficiency of the perception task.

Optionally, the paging message carries the first configuration information. In this way, a success rate of receiving the first configuration information can be improved; in addition, when receiving the paging message, the terminal device may determine, based on the second configuration information in the paging message, whether the terminal device needs to execute the perception task, and establish no RRC connection to the access network device when the terminal device does not need to execute the perception task, to save air interface resources.

Optionally, the paging message carries a paging cause value, and the paging cause value indicates that the paging message is triggered by the perception task. This helps the terminal device determine whether to establish a connection to the access network device.

In some possible implementations, the first configuration information further includes one or more of the following information: a measurement period of the perception task, a reporting trigger mode of a perception result of the perception task, a data reporting mode of the perception result of the perception task, a reporting interval of the perception result of the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

In some possible implementations, the request information and/or the first configuration information further include/includes reference information of the perception task and/or an identifier of the perception task. The reference information includes a mobile country code and/or a mobile network code of a communication network for executing the perception task.

In some possible implementations, before the core network functional entity sends the first configuration information, the core network functional entity may further perform validity authentication on the perception task, and send the first configuration information to the access network device only when the authentication succeeds.

In this implementation, execution of an invalid perception task by the terminal device can be avoided, to avoid a waste of resources of the terminal device.

According to a second aspect, this application provides a communication method for executing a perception task. The method includes: An access network device receives first configuration information of a perception task from a core network functional entity. The first configuration information includes an identifier of a communication device and second area range information, and the second area range information indicates to execute the perception task within a second area range. The access network device sends second configuration information of the perception task to a terminal device based on the identifier of the communication device. The second configuration information includes the second area range information.

In the communication method, after receiving configuration information of the perception task from the core network functional entity, the access network device delivers the configuration information of the perception task to the terminal device, to enable the perception task to be executed by the terminal device, so that the perception task can be executed.

In addition, in the communication method, the configuration information of the perception task delivered by the access network device to the terminal device is received from the core network functional entity. In comparison with that the access network device receives the configuration information of the perception task from a server in a data network, this can reduce a transmission latency of the configuration information of the perception task, to reduce a latency of completing the perception task.

In some possible implementations, that the access network device sends second configuration information to a terminal device based on the identifier of the communication device includes: When the identifier of the communication device includes an identifier of the access network device, the access network device determines an identifier of a terminal device that is configured to execute the perception task within the second area range. The access network device sends the second configuration information to the terminal device.

In this implementation, after receiving the first configuration information of the perception task from the core network functional entity, the access network device determines the terminal device that is to execute the perception task. In some embodiments, the access network device performs terminal device-level division on the perception task. In comparison with an implementation in which the core network functional entity performs terminal device-level division on the perception task, in this implementation, because the access network device can learn of a current connection status of the terminal device, the access network device can preferentially select a terminal device in a connected mode to execute the perception task. In comparison with that the access network device selects a terminal device in a non-connected mode, the access network device preferentially selects the terminal device in the connected mode. This can reduce a latency caused by paging the terminal device.

In some possible implementations, that access network device sends second configuration information to a terminal device based on the identifier of the communication device includes: When the identifier of the communication device includes the identifier of the terminal device, the access network device sends the second configuration information to the terminal device.

In this implementation, the first configuration information received by the access network device from the core network functional entity includes the identifier of the terminal device that is to execute the perception task. In some embodiments, the core network functional entity performs terminal device-level division on the perception task.

In this implementation, the core network functional entity indicates, to the access network device, the terminal device that is configured to execute the perception task. In comparison with that the access network device performs UE-level division to determine the terminal device that is configured to execute the perception task, complexity of the access network device can be simplified.

In some possible implementations, before that the access network device sends second configuration information to a terminal device, the method further includes: The access network device determines that a first terminal device in the terminal device is in an idle mode or an inactive mode. The access network device sends a paging message to the first terminal device.

The access network device first determines whether the terminal device is in the idle mode or the inactive mode, and sends the paging message to the first terminal device in the idle mode or the inactive mode, so that an RRC connection is established between the first terminal device and the access network device. In this way, even if the core network functional entity or the access network device selects the terminal device in the non-connected mode to execute the perception task, it can be ensured that the terminal devices can enter the connected mode to receive the second configuration information of the perception task, to execute the perception task, so that execution of the perception task can be ensured.

In some possible implementations, the paging message carries the second configuration information.

The paging message carries the second configuration information, so that when receiving the paging message, the terminal device may determine, based on the second configuration information in the paging message, whether the terminal device needs to execute the perception task. When determining that the perception task does not need to be executed, the terminal device does not need to establish an RRC connection to the access network device and then receive the second configuration information to determine that the perception task does not need to be executed, to save air interface resources.

In some possible implementations, the first configuration information and the second configuration information further include one or more of the following information: a measurement period of the perception task, a reporting trigger mode of a perception result of the perception task, a data reporting mode of the perception result of the perception task, a reporting interval of the perception result of the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

In this implementation, the measurement period is configured for the terminal device, so that a waste of resources of the terminal device caused by continuous execution of the perception task can be avoided. The reporting interval, the quantity of reporting times, or the reporting time length is configured for the terminal device, so that a waste of resources of the terminal device caused by continuous reporting of the perception result can be avoided. The reporting mode is configured for the terminal device, so that a timeliness requirement of a task trigger source for the perception result can be satisfied or a waste of resources of the terminal device can be avoided. For example, when the task trigger source has a real-time performance requirement for the perception result, the terminal device may be configured to report the perception result in real time; otherwise, the terminal device may be configured to report the perception result by using a log, to avoid a waste of energy consumption resources and a waste of air interface resources of the terminal device caused by real-time reporting of the perception result. The reporting type is configured for the terminal device. This helps the terminal device determine, based on a capability of the terminal device, whether semantic extraction needs to be performed on perception data, to save air interface transmission resources. The data anonymization indication information is configured for the terminal device. This helps protect privacy of the terminal device.

In some possible implementations, the first configuration information and the second configuration information further include reference information of the perception task or an identifier of the perception task, and the reference information of the perception task includes a mobile country code and/or a mobile network code of a communication network for executing the perception task.

In this implementation, the identifier of the perception task is configured for the terminal device, to distinguish different perception tasks and help determine a correspondence between the perception task and the terminal device. The reference information is configured for the terminal device. This helps accurately activate a terminal device in a corresponding network to execute the perception task, to avoid a problem of difficulty in exchanging management information caused by activating a terminal device across networks to execute the perception task.

According to a third aspect, this application provides a communication method. The method includes: A terminal device receives second configuration information of a perception task from an access network device. The second configuration information includes second area range information, and the second area range information indicates to execute the perception task within a second area range. The terminal device executes the perception task based on the second configuration information.

With reference to the third aspect, in a first possible implementation, the second configuration information further includes one or more of the following information: a measurement period of the perception task, a reporting trigger mode of a perception result of the perception task, a data reporting mode of the perception result of the perception task, a reporting interval of the perception result of the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

With reference to the third aspect or the first possible implementation, in a second possible implementation, the second configuration information further includes reference information of the perception task and/or an identifier of the perception task. The reference information of the perception task includes a mobile country code and/or a mobile network code of a communication network for executing the perception task.

According to a fourth aspect, a communication apparatus is provided to implement the foregoing method. The communication apparatus includes a corresponding module, unit, or means for implementing the foregoing method. The module, the unit, or the means may be implemented by hardware, implemented by software, or implemented by executing corresponding software by hardware. The hardware or the software includes one or more modules or units corresponding to the foregoing function.

The communication apparatus may be the network functional entity in the first aspect, or an apparatus including a network functional entity, or an apparatus included in a network functional entity, for example, a chip. Alternatively, the communication apparatus may be the access network device in the second aspect, or an apparatus including an access network device, or an apparatus included in an access network device, for example, a chip. Alternatively, the communication apparatus may be the terminal device in the third aspect, or an apparatus including a terminal device, or an apparatus included in a terminal device, for example, a chip.

According to a fifth aspect, a communication apparatus is provided. The communication apparatus includes a processor and a memory. The memory is configured to store computer instructions. When the processor executes the instructions, the communication apparatus is enabled to perform the method in any one of the foregoing aspects.

The communication apparatus may be the network functional entity in the first aspect, or an apparatus including a network functional entity, or an apparatus included in a network functional entity, for example, a chip. Alternatively, the communication apparatus may be the access network device in the second aspect, or an apparatus including an access network device, or an apparatus included in an access network device, for example, a chip. Alternatively, the communication apparatus may be the terminal device in the third aspect, or an apparatus including a terminal device, or an apparatus included in a terminal device, for example, a chip.

According to a sixth aspect, a communication apparatus is provided. The communication apparatus includes an interface circuit and a logic circuit. The interface circuit may be a code/data read/write interface circuit. The interface circuit is configured to obtain input information and/or output information. The logic circuit is configured to perform the method in any one of the foregoing aspects, and process and/or generate the output data based on the input information.

In a possible implementation, the communication apparatus may be the core network functional entity in the first aspect, or an apparatus including a core network functional entity, or an apparatus included in a core network functional entity, for example, a chip. In this case, the input information includes request information of a perception task, and the output information includes first configuration information of the perception task.

Optionally, the input information may further include one or more of mobility information, perception capability information, and task subscription information of a terminal device.

Optionally, the input information may further include a type of the perception task, and the type includes one or more of the following types: terahertz imaging perception, camera visual perception, channel state information perception, or location perception.

Optionally, the input information and the output information may further include reference information of the perception task and/or an identifier of the perception task, and the reference information includes a mobile country code and/or a mobile network code of a communication network for executing the perception task.

In some possible designs, the communication apparatus may be the access network device in the second aspect, or an apparatus including an access network device, or an apparatus included in an access network device, for example, a chip. In this case, the input information includes an identifier of a communication device and first configuration information of a perception task, and the output information includes second configuration information of the perception task.

In some possible designs, the communication apparatus may be the terminal device in the third aspect, or an apparatus including a terminal device, or an apparatus included in a terminal device, for example, a chip. In this case, the input information includes second configuration information of a perception task, and the output information includes an execution result of the perception task.

According to a seventh aspect, a communication apparatus is provided. The communication apparatus includes at least one processor. The processor is configured to execute a computer program or instructions stored in a memory, to enable the communication apparatus to perform the method in any one of the foregoing aspects. The memory may be coupled to the processor, or may be independent of the processor.

The communication apparatus may be the network functional entity in the first aspect, or an apparatus including a network functional entity, or an apparatus included in a network functional entity, for example, a chip. Alternatively, the communication apparatus may be the access network device in the second aspect, or an apparatus including an access network device, or an apparatus included in an access network device, for example, a chip. Alternatively, the communication apparatus may be the terminal device in the third aspect, or an apparatus including a terminal device, or an apparatus included in a terminal device, for example, a chip.

According to an eighth aspect, a computer-readable storage medium is provided. The computer-readable storage medium stores instructions. When the instructions are run on a communication apparatus, the communication apparatus is enabled to perform the method in any one of the foregoing aspects.

The communication apparatus may be the network functional entity in the first aspect, or an apparatus including a network functional entity, or an apparatus included in a network functional entity, for example, a chip. Alternatively, the communication apparatus may be the access network device in the second aspect, or an apparatus including an access network device, or an apparatus included in an access network device, for example, a chip. Alternatively, the communication apparatus may be the terminal device in the third aspect, or an apparatus including a terminal device, or an apparatus included in a terminal device, for example, a chip.

According to a ninth aspect, a computer program product including instructions is provided. When the computer program product runs on a communication apparatus, the communication apparatus is enabled to perform the method in any one of the foregoing aspects.

The communication apparatus may be the network functional entity in the first aspect, or an apparatus including a network functional entity, or an apparatus included in a network functional entity, for example, a chip. Alternatively, the communication apparatus may be the access network device in the second aspect, or an apparatus including an access network device, or an apparatus included in an access network device, for example, a chip. Alternatively, the communication apparatus may be the terminal device in the third aspect, or an apparatus including a terminal device, or an apparatus included in a terminal device, for example, a chip.

According to a tenth aspect, a communication apparatus is provided (for example, the communication apparatus may be a chip or a chip system). The communication apparatus includes a processor, configured to implement the function in any one of the foregoing aspects. In a possible design, the communication apparatus further includes a memory, and the memory is configured to store program instructions and data. When the communication apparatus is a chip system, the communication apparatus may include a chip, or may include a chip and another discrete device.

For technical effects achieved by any design manner of the fourth aspect to the tenth aspect, refer to technical effects achieved by different design manners of the first aspect, the second aspect, or the third aspect. Details are not described herein again.

### BRIEF DESCRIPTION OF DRAWINGS

FIG. 1 is a schematic diagram of a communication system according to an embodiment of this application;

FIG. 2 is a schematic flowchart of a communication method according to an embodiment of this application;

FIG. 3 is a schematic flowchart of a communication method according to another embodiment of this application;

FIG. 4A and FIG. 4B are a schematic flowchart of a communication method according to another embodiment of this application;

FIG. 5 is a schematic flowchart of a communication method according to another embodiment of this application;

FIG. 6 is a schematic flowchart of a communication method according to another embodiment of this application;

FIG. 7 is a schematic flowchart of a communication method according to another embodiment of this application;

FIG. 8 is a schematic flowchart of a communication method according to another embodiment of this application;

FIG. 9 is a schematic composition diagram of a communication apparatus according to an embodiment of this application;

FIG. 10 is a schematic diagram of a structure of a network functional entity according to an embodiment of this application;

FIG. 11 is a schematic diagram of a structure of an access network device according to an embodiment of this application; and

FIG. 12 is a schematic diagram of a structure of a terminal device according to an embodiment of this application.

### DESCRIPTION OF EMBODIMENTS

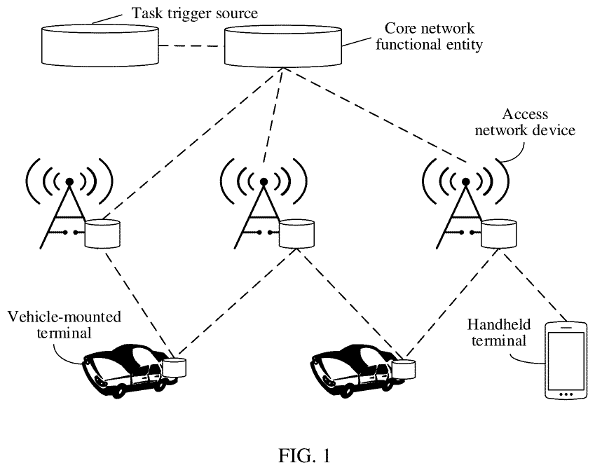

FIG. 1 is a schematic diagram of a communication system according to an embodiment of this application. As shown in FIG. 1, the communication system in this application may include a task trigger source, a core network functional entity, an access network device, and a terminal device. The terminal device may include a vehicle-mounted terminal and a handheld terminal. In the communication system, the task trigger source may communicate with the core network functional entity. The core network functional entity may communicate with the access network device. Optionally, the core network functional entity may further communicate with the terminal device. The access network device may communicate with the terminal device.

The task trigger source may be understood as a device that needs to use environment information within a specified area range. For example, the task trigger source may be an operation administration and maintenance (OAM) system, a terminal, an access network device, or a core network element. The task trigger source includes a device that is configured to request a perception task.

The operation administration and maintenance system includes: a device for performing routine operations such as analysis, prediction, planning, configuration, test, and/or fault management on an access network and services thereof.

The terminal device includes user equipment (UE), a cellular phone, a cordless phone, a session initiation protocol (SIP) phone, a wireless local loop (WLL) station, a personal digital assistant (PDA), a handheld device having a wireless communication function, a computing device, or another processing device connected to a wireless modem, a vehicle-mounted device, a wearable device, a virtual reality (VR) terminal device, an augmented reality (AR) terminal device, a terminal in industrial control, a terminal in vehicle to everything (V2X), a terminal in remote medical, a terminal in a smart grid, a terminal in transportation safety, a terminal in a smart city, a terminal in a smart home, a machine type communication (MTC) terminal, and the like.

The access network device in embodiments of this application is a device that provides a wireless communication function for the terminal device.

Optionally, the access network device includes but is not limited to a next generation base station (gNB) in 5G, a transmission reception point (TRP), an evolved NodeB (eNB), a home base station (HNB), a baseband unit (BBU), a transmitting point (TP), a mobile switching center, and the like. Optionally, the base station in this embodiment of this application may include base stations in various forms, for example, a macro base station, a micro base station (also referred to as a small cell), and an access point. This is not specifically limited in this embodiment of this application.

Optionally, the access network device in embodiments of this application may include a central unit (CU) and a distributed unit (DU). The CU and the DU may be physically separated, or may be deployed together. This is not specifically limited in embodiments of this application. The CU and the DU may be connected through an interface, for example, an F1 interface. The CU and the DU may be obtained through division based on protocol layers of a wireless network. For example, functions of an RRC protocol layer and a PDCP protocol layer are set in the CU, and functions of an RLC protocol layer, a media access control (MAC) protocol layer, a physical (PHY) protocol layer, and the like are set in the DU. It may be understood that processing function division of the CU and the DU based on the protocol layers is merely an example, and there may be other division. This is not specifically limited in embodiments of this application.

In an example, the access network device may be an open-radio access network (O-RAN) device, and the O-RAN device may include an open-distributed unit (O-DU) and an open-central unit (O-CU).

The core network functional entity includes: a network functional entity that transmits non-access stratum (NAS) control information with the access network device based on a next generation-application protocol (NG-AP) or a stream control transmission protocol (SCTP), and a network functional entity that transmits user plane data information with the access network device based on a general packet radio service (GPRS)-tunnel transport protocol. The network functional entity may be understood as an apparatus that can implement one or more network functions, and the apparatus may be implemented in a software and/or hardware manner.

It may be understood that the communication system shown in FIG. 1 is merely an example communication system. A quantity of devices included in the communication system in this embodiment of this application is not limited. In addition, the communication system in this embodiment of this application may further include another device. For example, the communication system in this embodiment of this application may further include a data network (DN).

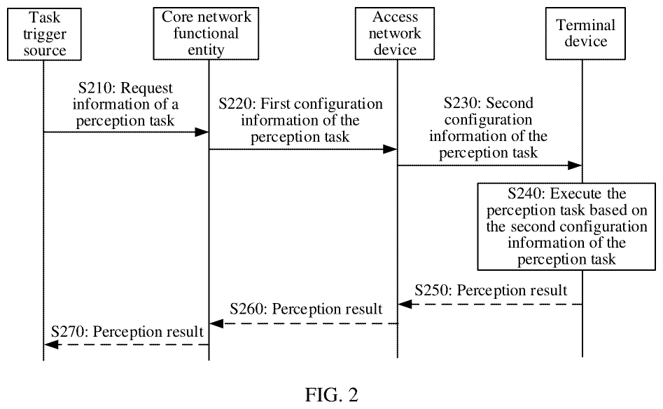

FIG. 2 is a schematic flowchart of a communication method according to an embodiment of this application. As shown in FIG. 2, the method may include the following steps.

S210: A core network functional entity receives request information of a perception task from a task trigger source. The request information includes first area range information, and the first area range information indicates to execute the perception task within a first area range.

Optionally, the core network functional entity may be an existing core network functional entity, or may be a newly added core network functional entity.

In an example, the core network functional entity may be an access and mobility management function (AMF) entity that is configured to manage mobility of a terminal device.

In another example, the core network functional entity may be a perception management function (PMF) entity in a core network. The PMF entity is configured to perform one or more of the following functions: a function of verifying validity of the perception task, and a function of dividing the perception task.

The perception task includes a task of obtaining perception information. In an example, the perception task includes an activity of collecting environment information through a sensor of the terminal device, for example, an activity of collecting environment information through a camera, a speed sensor, or the like on the terminal device.

Optionally, the core network functional entity may receive the request information from the task trigger source, or may receive request information that is forwarded by the task trigger source through another core network functional entity. For example, when the core network functional entity is an entity other than the AMF entity, the core network functional entity may receive a task request that is forwarded by the task trigger source through the AMF entity.

In this embodiment, the request information of the perception task may be understood as request information used for requesting to execute the perception task within the first area range.

In this embodiment, the first area range information may be represented by a tracking area (TA), and the TA may be represented by a tracking area code (tracking area code, TAC) or a tracking area identity (TAI). The TAC is defined as a index number of the TA assigned by an operator. A TAI is a global identity, including one or more of an MCC, an MNC, and a TAC.

In this embodiment, optionally, the request information may further include at least one of the following: a type of the perception task, reference information of the perception task, or an identifier of the perception task.

Optionally, the type of the perception task may include terahertz (THz) imaging perception, camera visual perception, channel state information (CSI) perception, a location perception, or the like.

The THz imaging perception includes a perception task using terahertz wave imaging. The THz imaging perception includes active THz imaging perception and passive THz imaging perception. The active THz imaging perception mainly uses a THz source to emit a THz wave of a specific frequency to irradiate an object, and uses a THz detector to receive a THz wave signal that passes through the object or is reflected by a surface of the object, to obtain intensity information of a THz wave emitted or reflected by each point of the object to execute a perception task of forming an image. The passive THz imaging perception mainly uses a high-sensitivity THz detector to receive a THz wave signal emitted by an object, to obtain intensity information of a THz wave emitted by each point of the object to execute a perception task of forming an image. The camera visual perception includes collecting image or video information through a camera. The CSI perception includes obtaining channel state information or improving spectral efficiency. The location perception includes obtaining location information of a terminal device or obtaining a map.

Optionally, the type of the perception task may be represented in a form of a task type identifier (ID). For example, a task type ID=1 indicates THz imaging, a task type ID=2 indicates camera visual perception, a task type ID=3 indicates CSI channel perception, and a task type ID=4 indicates user location perception. This patent application does not limit a binding between a number of the task type ID and the type of the perception task, and does not limit another task type or another type of task.

The reference information of the perception task indicates a communication network for executing the perception task. Optionally, the reference information of the perception task may include a mobile country code (MCC) and/or a mobile network code (MNC) of the communication network for executing the perception task. The MCC indicates that a communication network of China is requested to execute the perception task, and the MNC indicates that a communication network of China Mobile is requested to execute the perception task.

The identifier of the perception task is used to distinguish different perception tasks. In an example, the identifier of the perception task is used to distinguish different perception tasks in perception tasks of a same type. For example, in a plurality of perception tasks of a same type, an identifier of each perception task is unique, and identifiers of a plurality of perception tasks of different types may be the same.

Optionally, eight bits may be used to indicate the identifier of the perception task. In this implementation, for perception tasks of a same type, one access network device may distinguish 256 perception tasks. For example, one access network device may support configuration of 256 perception tasks of a same type.

S220: The core network functional entity sends first configuration information of the perception task to the access network device. The first configuration information includes an identifier of the communication device and second area range information. The second area range information indicates to execute the perception task within a second area range. The second area range is a subset of the first area range. Correspondingly, the access network device receives the first configuration information from the core network functional entity.

That the second area range is a subset of the first area range may mean that the second area range is a sub-area range of the first area range. That the second area range is a sub-area range of the first area range may be understood as: The second area range includes all or a part of the first area range.

In an example, when the first area range includes 10 tracking areas: a cell 1 to a cell 10, the second area range may include all or a part of the 10 tracking areas. For example, the second area range includes five tracking areas: the cell 1 to the cell 5. In this embodiment, the identifier of the communication device may include an identifier of the access network device and/or an identifier of the terminal device. If the identifier of the communication device includes the identifier of the terminal device, it may be considered that the core network functional entity performs terminal device-level division on the perception task. If the identifier of the communication device includes the identifier of the access network device, it may be considered that the core network functional entity performs access network device-level division on the perception task.

That the core network functional entity performs access network device-level on the perception task may be understood as that the core network functional entity determines, based on the first area range information, an access network device whose service area range includes a subset (that is, the second area range) of the first area range, and includes an identifier of the access network device in the first configuration information of the perception task. When the identifier of the communication device includes the identifier of the access network device, the service area range of the access network device includes the second area range, in other words, the access network device is an access network device whose service area range includes the second area range.

That the core network functional entity performs terminal device-level division on the perception task may be understood as that the core network functional entity determines, based on the first area range information, a terminal device that is to execute the perception task, and specifies the terminal device to execute the perception task in a subset (that is, the second area range) of the first area range. For example, when the identifier of the communication device includes the identifier of the terminal device, the terminal device executes the perception task when a serving cell includes the second area range.

In some implementations, the identifier of the terminal device may be represented as a permanent equipment identifier (PEI), an international mobile equipment identity (IMEI), an international mobile subscription identity (IMSI), a subscription permanent identifier (SUPI), a globally unique temporary UE identity (GUTI), or a subscription concealed identifier (SUCI).

In some other implementations, the identifier of the terminal device may alternatively be indicated by using a specified condition. For example, configuration information may carry the specified condition, and the identifier of the terminal device includes an identifier of the terminal device that satisfies the specified condition. In this case, a terminal device corresponding to the identifier of the terminal device that satisfies the specified condition may be referred to as a terminal device group, and the specified condition may be referred to as indication information of the terminal device group. An example of the specified condition includes: A remainder of dividing the identifier of the terminal device by 3 is 1, or a remainder of dividing the identifier of the terminal device by 10 is 2.

The identifier of the access network device may include an identity (ID) of the access network device, and the ID of the access network device may be represented by a cell ID and/or a cell-radio network temporary identifier (C-RNTI).

For example, the identifier of the access network device may be represented by an evolved universal terrestrial radio access network cell identifier (ECD. The ECI may include a base station ID and a cell ID. The base station ID and the cell ID each occupy a specific quantity of bits. For example, when the ECI occupies 28 bits, the base station ID occupies 20 bits, and the cell ID occupies 8 bits. In a hexadecimal format, the ECI is a seven-digit number, the base station ID is a five-digit number, and the cell ID is a two-digit number.

For another example, the identifier of the access network device may be represented by a new radio cell identity (NCD. The NCI may include a base station ID and a cell ID, and the base station ID and the cell ID each occupy a specific quantity of bits. For example, when the NCI occupies 36 bits, the base station ID occupies 22 bits to 32 bits, and the cell ID are occupies 4 bits to 14 bits.

In this embodiment, optionally, the first configuration information may further include one or more of the following information: the identifier of the perception task, a measurement period of the perception task, a reporting trigger mode of a perception result of the perception task, a data reporting mode of the perception result of the perception task, a reporting interval of the perception result of the perception task, perception capability information required by the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

The measurement period of the perception task indicates an interval at which the terminal device executes the perception task, in other words, the measurement period of the perception task indicates an interval between time when the terminal device executes the perception task this time and time when the terminal device executes the perception task next time. In an example, the measurement period may be 1 millisecond (ms), 2 ms, 4 ms, or 8 ms. Specific time is not limited in this patent application.

The reporting trigger mode of the perception result indicates when the terminal device reports the perception result obtained by executing the perception task. For example, the reporting trigger mode of the perception task may include periodic reporting or radio resource management (RRM) event reporting.

The periodic reporting includes that the terminal device periodically reports the perception result of the perception task. The RRM event reporting includes that the terminal device reports the perception result of the perception task when a specified RRM event occurs.

In an example, the RRM event may be A1, A2, A3, A4, A5, B1, or B2. Event A1 indicates that a serving cell is better than an absolute threshold. Event A2 indicates that a serving cell is worse than an absolute threshold. Event A3 indicates that a neighboring cell is better than a serving cell. Event A4 indicates that a neighboring cell is better than an absolute threshold. Event A5 indicates that a serving cell is worse than an absolute threshold and a neighboring cell is better than an absolute threshold. Event B1 indicates that an inter-RAT neighboring cell is better than an absolute threshold. Event B2 indicates that a serving cell is worse than an absolute threshold 1 and an inter-RAT neighboring cell is better than an absolute threshold 2.

The data reporting mode of the perception result indicates a mode in which the terminal device reports the perception result. For example, the data reporting mode of the perception result may include instant reporting (that is, immediate reporting after collection) or reporting using a log (that is, recording collected data in the log and reporting the data after specified time).

The reporting interval of the perception result indicates a period of reporting the perception result by the terminal device by using a log, in other words, indicates an interval between time when the terminal device reports the perception result this time and time when the terminal device reports the perception result next time. In an example, the reporting interval may be 1 ms, 2 ms, 4 ms, or 8 ms. Specific time is not limited in this patent application.

The quantity of reporting times of the perception result indicates a total quantity of times that the terminal device reports the perception result. After the quantity of times that the terminal device reports the perception result reaches the total quantity of times, the terminal device may stop reporting the perception result, in other words, may stop executing the perception task, to avoid a waste of resources of the terminal device. In an example, the quantity of reporting times may be represented as 100 times, 200 times, or another quantity of times. This is not limited in this patent application.

The reporting time length of the perception result indicates a total time length in which the terminal device reports the perception result. After the time length in which the terminal device reports the perception result reaches the total time length, the terminal device may no longer report the perception result, in other words, may stop executing the perception task. For example, the reporting time length of the perception result is 20 minutes or 2 hours. A specific time length is not limited in this patent application.

The data reporting type of the perception result indicates whether the perception result reported by the terminal device is original data obtained by the terminal device through perception or data obtained by processing the original data. Examples of the original data are an image and channel quality. The processed data may be understood as data obtained through semantic extraction. Compared with the original data, the processed data is compressed. Therefore, an amount of data to be transmitted can be reduced, and privacy can be ensured to some extent.

The sensor information indicates sensor information used by the terminal device. In an example, the sensor information may include atmospheric pressure information within the second area range (indicating the terminal device to obtain the atmospheric pressure information within the second area range), speed information of the terminal device (indicating the terminal device to perceive the speed information of the terminal device), and positioning information of the terminal device (indicating the terminal device to perceive location information of the terminal device).

The data anonymization indication information of the perception result indicates whether the perception result reported by the terminal device includes UE ID information.

The perception capability information indicates a perception capability that needs to be used by the terminal device to execute the perception task. The perception capability includes a THz imaging capability, a camera capability, a global positioning capability (GPS) capability, or the like.

In this embodiment, optionally, the first configuration information may further include the reference information of the perception task. The reference information of the perception task indicates the mobile country code and/or the mobile network code of the communication network for executing the perception task.

Optionally, the first configuration information may further include the identifier of the perception task.

Optionally, when the type of the perception task is the user location perception, the first configuration information may further include positioning method information of a user location. The positioning method information indicates a method for perceiving the user location by the terminal device. For example, the positioning method may include a cell-ID based positioning method or a GPS positioning method.

S230: The access network device sends second configuration information of the perception task to the terminal device. The second configuration information includes the second area range information. Correspondingly, the terminal device receives the second configuration information from the access network device.

The second configuration information may indicate or activate or configure the terminal device to execute the perception task within the second area range.

In an implementation, after the access network device receives the first configuration information of the perception task, the access network device may determine whether the communication device indicated by the identifier of the communication device in the first configuration information is the access network device or the terminal device.

When determining that the communication device indicated by the identifier of the communication device in the first configuration information is the access network device, the access network device determines the identifier of the terminal device that is configured to execute the perception task. In other words, the access network device performs terminal device-level division on the perception task based on the first configuration information, and then the access network device sends the second configuration information to the determined terminal device.

When the access network device determines that the communication device indicated by the identifier of the communication device in the first configuration information is the terminal device, the access network device may send the second configuration information to the terminal device indicated by the identifier of the communication device in the first configuration information.

Optionally, the second configuration information may include one or more of the following information: the identifier of the perception task, the measurement period of the perception task, the reporting trigger mode of the perception result of the perception task, the data reporting mode of the perception result of the perception task, the reporting interval of the perception result of the perception task, the quantity of reporting times of the perception result of the perception task, the reporting time length of the perception result of the perception task, the data reporting type of the perception result of the perception task, the sensor information corresponding to the perception task or the data anonymization indication information of the perception result of the perception task, and the reference information of the perception task.

S240: The terminal device executes the perception task based on the second configuration information. For example, the terminal device executes the perception task within the second area range.

The core network functional entity receives the request information of the perception task and sends configuration information of the perception task to the access network device. In comparison with that a network functional entity other than the core network receives the request information of the perception task and sends the configuration information of the perception task to the access network device, a procedure of delivering the perception task needs to pass through an access network and the core network instead of a data network. Therefore, a latency of delivering the perception task can be reduced, and a latency of implementing the perception task can be reduced.

For example, the perception task includes traffic route planning. When a traffic route planning center needs to obtain location information of a plurality of vehicles within a specific area range to plan a traffic route within the area range, the traffic route planning center as the task trigger source may send request information of a perception task of obtaining the location information of the vehicle within the area range to the core network functional entity. The core network device may deliver, via the access network device, the perception task to a vehicle-mounted terminal having a location perception capability. After perceiving location information of the vehicle-mounted terminal, the vehicle-mounted terminal may report the location information to the traffic route planning center via the access network device, so that the traffic route planning center provides a traffic route planning service based on the information.

In this embodiment, the perception task requested by the task trigger source is finally executed by one or more terminal devices. A perception task executed by each terminal device may be referred to as a subtask of the perception task requested by the task trigger source.

Optionally, when the first configuration information includes the identifier of the terminal device, the first configuration information may further include a sub-identifier of the perception task. Correspondingly, the second configuration information may further include the sub-identifier of the perception task, and the sub-identifier of the perception task indicates a subtask of the perception task. For example, when the perception task is configured to be executed by a plurality of terminal devices, a perception task executed by each terminal device is referred to as a subtask, and a sub-identifier may be allocated to each subtask based on an identifier of the perception task, to distinguish each subtask. In an example, eight bits may be used to represent a subtask identifier. In this case, because the eight bits usually indicate only 256 subtask identifiers, one perception task may be divided into 256 subtasks, that is, one perception task may be cooperatively completed by 256 terminal devices.

In some implementations of this embodiment, optionally, after executing the perception task, the terminal device may further send a perception result to the access network device, for example, perform S250. The access network device may further forward the perception result to the core network functional entity, for example, perform S260. Optionally, in this embodiment, after receiving the perception result, the core network functional entity may send the perception result to the task trigger source, for example, perform S270.

In some implementations of this embodiment, optionally, before S230, the access network device may determine whether UE indicated by a UE ID is in a radio resource control (RRC)-inactive (inactive) mode or an RRC-active (active) mode.

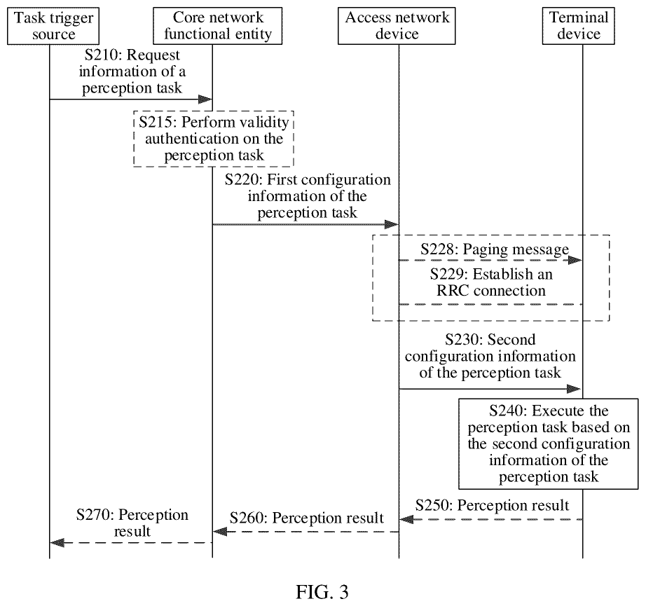

If the access network device determines that the UE is in the RRC-active mode, S230 is performed. If the access network device determines that the UE is in the RRC-inactive mode, as shown in FIG. 3, before S230, this embodiment may further include: S228: The access network device sends a paging message to the UE. S229: The UE establishes an RRC connection to the access network device.

Optionally, the paging message may include a paging cause value. An example of the paging cause value is task triggering. Optionally, the paging message may include all or a part of the second configuration information. In this way, a success rate of receiving the second configuration information by the UE can be improved.

In some implementations of this embodiment, optionally, as shown in FIG. 3, this embodiment may further include: S215: Verify validity of the perception task, and perform subsequent operations only when the verification succeeds. The verifying validity of the perception task may include: verifying validity of a requester of the perception task, and/or verifying validity of the type of the perception task.

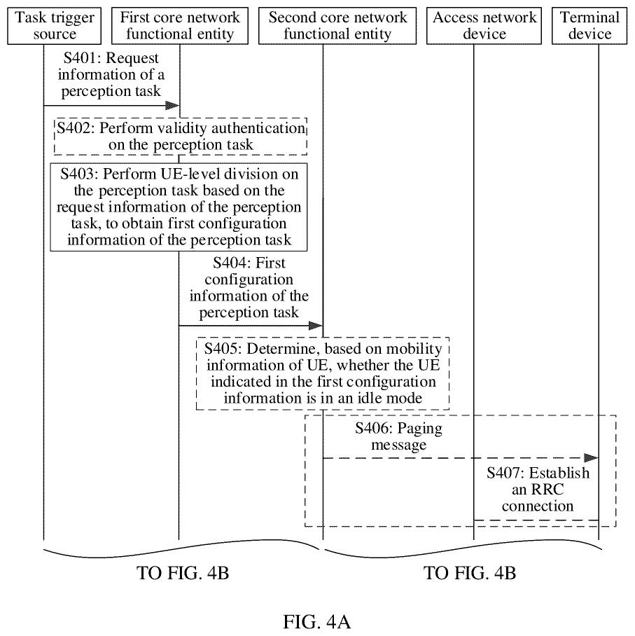

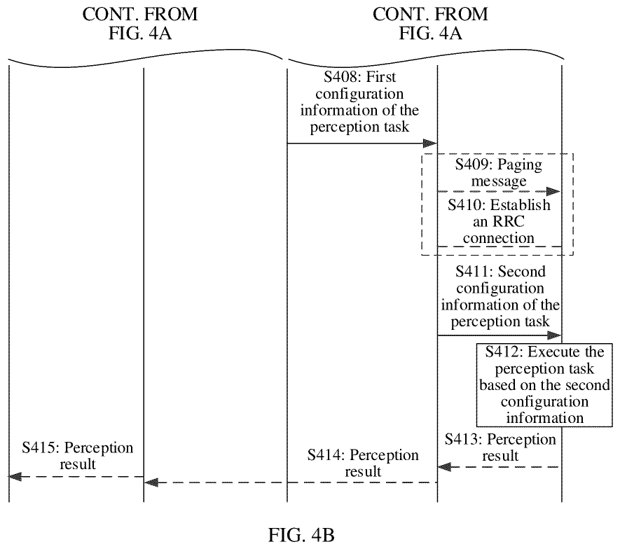

FIG. 4A and FIG. 4B are a schematic flowchart of a communication method according to another embodiment of this application. A first core network functional entity may be a network functional entity that is in a core network and that is configured to manage a perception task (for example, divide and deliver the task). A second core network functional entity may be a network functional entity that has a mobility management function for a terminal device. An example of the second core network functional device is an AMF network element. Mobility management (MM) includes management of location information and service continuity of a mobile terminal, to provide guarantee for application of various network services.

S401: The first core network functional entity receives request information of a perception task from a task trigger source. For this step, refer to related content in which the core network functional entity receives the request information from the task trigger source in S210.

S402: The first core network functional entity performs validity authentication on the perception task. For this step, refer to S215.

S403: The first core network functional entity performs UE-level division on the perception task based on the request information of the perception task, to obtain first configuration information of the perception task. An identifier of a communication device in the first configuration information includes a UE ID. Usually, S403 and subsequent steps are performed only when the validity authentication succeeds.

S404: The first core network functional entity sends the first configuration information of the perception task to the second core network functional entity.

S405: The second core network functional entity determines, based on mobility information of UE, whether the UE indicated in the first configuration information is in an idle mode. If the UE is in the idle mode, the second core network functional entity performs S406, S407, and S408. If the UE is in a non-idle mode, S408 is performed.

S406: The second core network functional entity sends a paging message to the UE indicated in the first configuration information.

S407: After receiving the paging message sent by the second core network functional entity, the UE performs an RRC connection establishment procedure with an access network device.

S408: The second core network functional entity sends the first configuration information of the perception task to the access network device. Correspondingly, the access network device receives the first configuration information.

S411: The access network device sends second configuration information of the perception task to the terminal device.

S412: The terminal device executes the perception task based on the second configuration information.

S413: The terminal device sends a perception result to the access network device.

S414: The access network device sends the perception result to the first core network functional entity. Optionally, the access network device may send the perception result to the first core network functional entity via the second core network functional entity.

S415: The first core network functional entity sends the perception result to the task trigger source.

Optionally, the paging message sent by the second core network functional entity may include a paging cause value. An example of the paging cause value is task triggering.

Optionally, the paging message may include all or a part of the first configuration information. In this way, a success rate of receiving the first configuration information by the UE can be improved.

Optionally, when the paging message in S406 includes the first configuration information, S411 may not be included in this embodiment.

Optionally, in this embodiment, S405 to S407 may not be performed. In this case, after receiving the first configuration information, the access network device may determine whether the terminal device is in a connected mode. If the terminal device is in a non-connected mode, S409 and S410 may be performed, and S411 continues to be performed. If the terminal device is in the connected mode, a procedure may start from S411.

S409: The access network device sends the paging message to the terminal device.

S410: The terminal device establishes an RRC connection to the access network device.

Optionally, when S409 is performed in this embodiment, if the paging message in S409 includes the second configuration information, S411 may not be performed.

For S409, S410, S411, S412, S413, S414, and S415 in this embodiment, refer to S228, S229, S230, S240, S250, S260, and S270 respectively.

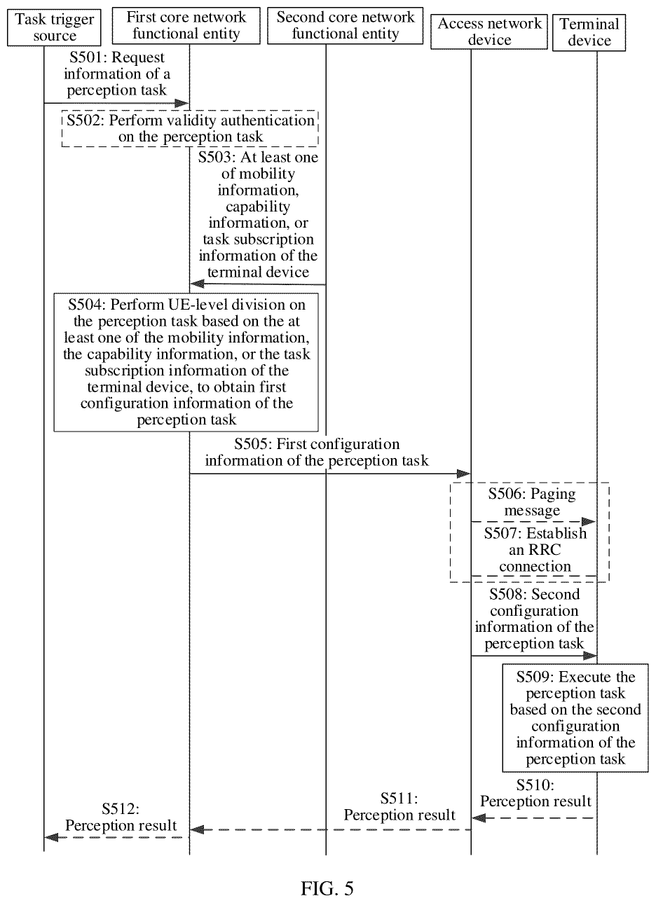

FIG. 5 is a schematic flowchart of a communication method according to still another embodiment of this application. A first core network functional entity may be a network functional entity that is in a core network and that is configured to manage a perception task (for example, divide and deliver the perception task). A second core network functional entity may be a network functional entity that has a mobility information management function for a terminal device. An example of the second core network functional device is an AMF network element.

S501: A task trigger source sends request information of a perception task to the first core network functional entity.

S502: The first core network functional entity performs validity authentication on the perception task.

In this embodiment, for S501 and S502, refer to S401 and S402 respectively.

S503: The first core network functional entity receives at least one of the following from the second core network functional entity: mobility information, capability information, or task subscription information of the terminal device.

S504: The first core network functional entity performs UE-level division on the perception task based on one or more of the mobility information, the capability information, and the task subscription information of the terminal device, to obtain first configuration information of the perception task. An identifier of a communication device in the first configuration information includes at least one UE ID.

The mobility information of the terminal device indicates a connection status between the terminal device and a core network. Optionally, the mobility information may further indicate information about a cell in which the terminal device is located.

When performing UE-level division on the perception task based on the mobility information of the terminal device, the first core network functional entity may preferentially select a terminal device in a connected mode to execute the perception task. In other words, the perception task may be preferentially divided to be executed by the terminal device in the connected mode.

The task subscription information of the terminal device indicates a subscribed perception task of the terminal device. The terminal device may execute the subscribed perception task.

When performing UE-level division on the perception task based on the task subscription information of the terminal device, the first core network functional entity may select a terminal device that subscribes to the perception task to execute the perception task. In other words, the perception task may be divided to be executed by the terminal device that subscribes to the perception task.

The capability information of the terminal device indicates a perception capability of the terminal device.

When performing UE-level division on the perception task based on the capability information of the terminal device, the first core network functional entity may select a terminal device that has a perception capability required by the perception task to execute the perception task. In other words, the perception task may be divided to be executed by the terminal device that has the perception capability required by the perception task.

S505: The first core network functional entity sends the first configuration information of the perception task to an access network device. Optionally, the first core network functional entity may send the first configuration information to the access network device via the second core network functional entity, or may send the first configuration information to the access network device without using the second core network functional entity.

When the terminal device is in a non-connected mode, after S505, a procedure may start from S506. When the terminal device is in the connected mode, a procedure may start from S508.

S506: The access network device sends a paging message to the terminal device.

S507: The terminal device establishes an RRC connection to the access network device.

S508: The access network device sends second configuration information of the perception task to the terminal device.

S509: The terminal device executes the perception task based on the second configuration information.

S510: The terminal device sends a perception result to the access network device.

S511: The access network device sends the perception result to the first core network functional entity.

S512: The first core network functional entity sends the perception result to the task trigger source.

Optionally, when the access network device performs S506, if the paging message in S506 includes the second configuration information, S508 may not be performed.

For S506, S507, S508, S509, S510, S511, and S512, refer to S228, S229, S230, S240, S250, S260, and S270 respectively.

Optionally, S503 may be performed before S502, or may be performed after S502, or S502 and S503 may be performed simultaneously.

In this embodiment, when the first core network functional entity performs UE-level division based on the mobility information of the terminal device, the first core network functional entity may select the UE in the connected mode. In this way, after receiving the first configuration information of the perception task, the second core network functional entity may forward the first configuration information to the access network device, without determining whether the UE is in an idle mode and sending the paging message to the UE.

In the embodiment shown in FIG. 4A and FIG. 4B or FIG. 5, optionally, the task request received by the first core network functional entity may be sent by the task trigger source to the first core network functional entity, may be forwarded by the task trigger source to the first core network functional entity via the second core network functional entity, or may be forwarded to the first core network functional entity via another core network functional entity.

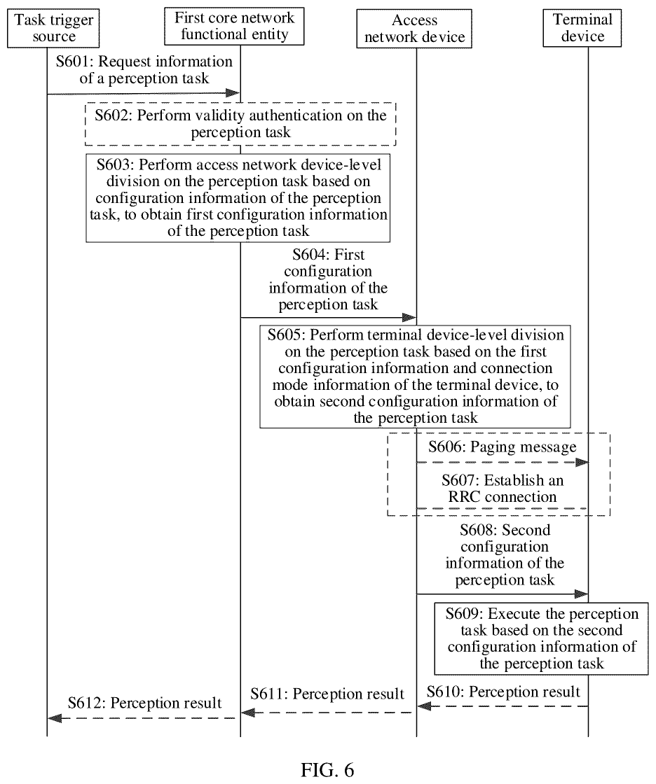

FIG. 6 is a schematic flowchart of a communication method according to another embodiment of this application. A first core network functional entity may be a network functional entity that is in a core network and that is configured to manage a perception task (for example, divide and deliver the perception task).

S601: The first core network functional entity receives request information of a perception task from a task trigger source.

S602: The first core network functional entity performs validity authentication on the perception task.

In this embodiment, for S601 and S602, refer to S401 and S402 respectively.

S603: The first core network functional entity performs access network device-level division on the perception task based on the request information of the perception task, to obtain first configuration information of the perception task. An identifier of a communication device in the first configuration information includes an identifier of an access network device.

S604: The first core network functional entity sends the first configuration information to the access network device. The identifier of the communication device in the first configuration information includes the identifier of the access network device.

Optionally, the first core network functional entity may send the first configuration information to the access network device via the second core network functional entity, or may send the first configuration information to the access network device without using the second core network functional entity. An example of the second core network functional entity is an AMF network element that has a mobility information management function for a terminal device.

S605: The access network device performs terminal device-level division on the perception task based on the first configuration information and connection mode information of the terminal device. In some embodiments, the access network device determines terminal devices that are to execute the perception task, and obtains identifiers of the terminal devices, to obtain second configuration information of the perception task.

For example, the access network device may preferentially select a terminal device in a connected mode to execute the perception task. In this way, paging of a terminal device in a non-connected mode can be avoided, and air interface resources can be saved.

Optionally, the access network device may further determine the identifiers of the terminal devices based on information such as capability information of the terminal devices and/or task subscription information of the terminal devices.

When the terminal device is in the non-connected mode, after S605, a procedure may start from S606. When the terminal device is in the connected mode, a procedure may start from S608.

S606: The access network device sends a paging message to the terminal device.

S607: The terminal device establishes an RRC connection to the access network device.

S608: The access network device sends second configuration information of the perception task to the terminal device.

S609: The terminal device executes the perception task based on the second configuration information.

S610: The terminal device sends a perception result to the access network device.

S611: The access network device sends the perception result to the first core network functional entity.

S612: The first core network functional entity sends the perception result to the task trigger source.

Optionally, when the access network device performs S606, if the paging message in S606 includes the second configuration information, S608 may not be performed.

For S606, S607, S608, S609, S610, S611, and S612, refer to S228, S229, S230, S240, S250, S260, and S270 respectively.

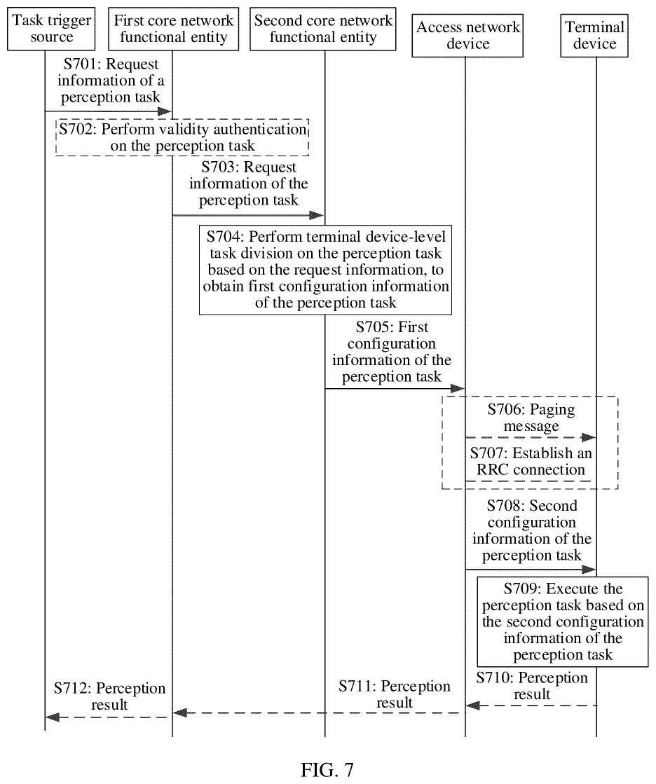

FIG. 7 is a schematic flowchart of a communication method according to another embodiment of this application. A first core network functional entity may be a network functional entity that is in a core network and that is configured to manage a perception task (for example, divide and deliver the perception task). A second core network functional entity may be a network functional entity that has a mobility information management function for a terminal device. An example of the second core network functional device is an AMF network element.

S701: A task trigger source sends request information of a perception task to the first core network functional entity.

S702: The first core network functional entity performs validity authentication on the perception task.

In this embodiment, for S701 and S702, refer to S401 and S402 respectively.

S703: The first core network functional entity sends the request information of the perception task to the second core network functional entity.

S704: The second core network functional entity performs terminal device-level task division on the perception task based on the request information, to obtain first configuration information of the perception task. An identifier of a communication device in the first configuration information includes an identifier of the terminal device.

Optionally, the second core network functional entity may further determine the first configuration information based on at least one of mobility information, capability information, or task subscription information of the terminal device.

S705: The second core network functional entity sends the first configuration information of the perception task to an access network device.

When the terminal device is in a non-connected mode, after S705, a procedure may start from S706. When the terminal device is in a connected mode, a procedure may start from S708.

S706: The access network device sends a paging message to the terminal device.

S707: The terminal device establishes an RRC connection to the access network device.

S708: The access network device sends second configuration information of the perception task to the terminal device.

S709: The terminal device executes the perception task based on the second configuration information.

S710: The terminal device sends a perception result to the access network device.

S711: The access network device sends the perception result to the first core network functional entity.

S712: The first core network functional entity sends the perception result to the task trigger source.

Optionally, when the access network device performs S706, if the paging message in S706 includes the second configuration information, S708 may not be performed.

For S705, S706, S707, S708, S709, S710, S711, and S712, refer to S408, S409, S410, S411, S412, S413, S414, and S415 respectively.

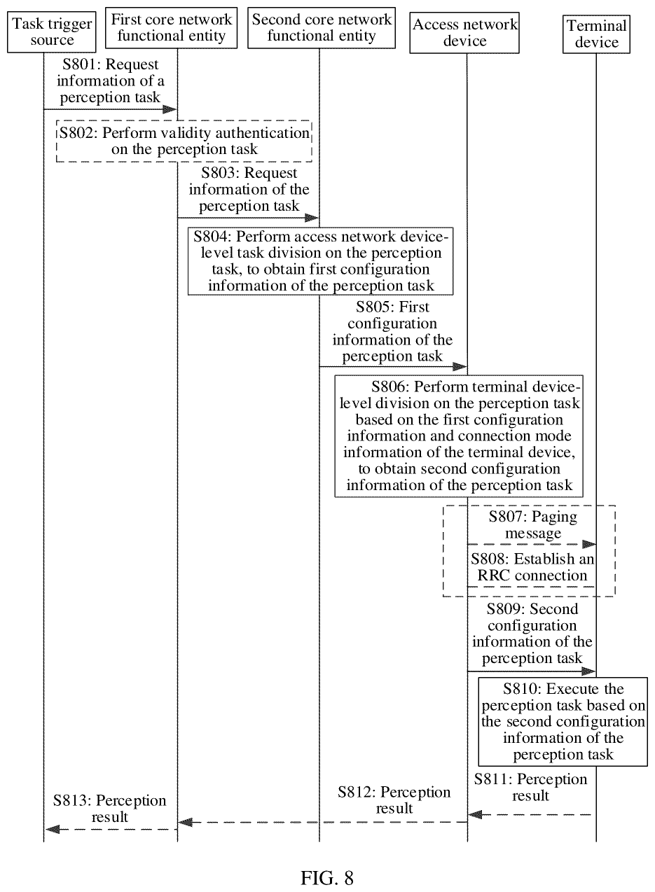

FIG. 8 is a schematic flowchart of a communication method according to another embodiment of this application. A first core network functional entity may be a network functional entity that is in a core network and that is configured to manage a perception task (for example, divide and deliver the perception task). A second core network functional entity may be a network functional entity that has a mobility information management function for a terminal device. An example of the second core network functional device is an AMF network element.

S801: A task trigger source sends request information of a perception task to the first core network functional entity.

S802: The first core network functional entity performs validity authentication on the perception task.

S803: The first core network functional entity sends the request information of the perception task to the second core network functional entity.

In this embodiment, for S801, S802, and S803, refer to S701, S702, and S703 respectively.

S804: The second core network functional entity performs access network device-level task division on the perception task based on the request information, to obtain first configuration information of the perception task. An identifier of a communication device in the first configuration information includes an identifier of an access network device.

S805: The second core network functional entity sends the first configuration information of the perception task to the access network device.

When the terminal device is in a non-connected mode, after S805, a procedure may start from S806. When the terminal device is in a connected mode, a procedure may start from S808.

S806: The access network device performs terminal device-level division on the perception task based on the first configuration information and connection mode information of the terminal device, to obtain second configuration information of the perception task.

S807: The access network device sends a paging message to the terminal device.

S808: The terminal device establishes an RRC connection to the access network device.

S809: The access network device sends second configuration information of the perception task to the terminal device.

S810: The terminal device executes the perception task based on the second configuration information.

S811: The terminal device sends a perception result to the access network device.

S812: The access network device sends the perception result to the first core network functional entity.

S813: The first core network functional entity sends the perception result to the task trigger source.

Optionally, when the access network device performs S807, if the paging message in S807 includes the second configuration information, S809 may not be performed.

For S805, refer to S705. For S806, refer to S605. For S807, S808, S809, S810, S811, S812, and S813, refer to S408, S409, S410, S411, S412, S413, S414, and S415 respectively.

In embodiments of this application, unless otherwise specified or a logical conflict occurs, terms and/or descriptions in different embodiments are consistent and may be mutually referenced, and technical features in different embodiments may be combined to form a new embodiment based on an internal logical relationship.

It may be understood that, in the foregoing embodiments, methods and/or steps implemented by each device may also be implemented by a component (for example, a chip or a circuit) that may be used in the device.

The foregoing mainly describes the solutions provided in this application from a perspective of interaction between devices. Correspondingly, this application further provides a communication apparatus. The communication apparatus is configured to implement the foregoing methods. The communication apparatus may be the terminal device in the foregoing method embodiments, an apparatus including the foregoing terminal device, or a component that may be used in the terminal device. Alternatively, the communication apparatus may be the network device in the foregoing method embodiments, an apparatus including the foregoing network device, or a component that may be used in the network device. It may be understood that, to implement the foregoing functions, the communication apparatus includes a corresponding hardware structure and/or software module for performing each function. A person skilled in the art should easily be aware that with reference to units and algorithm steps in the examples described in embodiments disclosed in this specification, this application can be implemented in a form of hardware or a combination of hardware and computer software. Whether a function is performed by hardware or hardware driven by computer software depends on particular applications and design constraint conditions of the technical solutions. A person skilled in the art may use different methods to implement the described functions for each particular application, but it should not be considered that the implementation goes beyond the scope of this application.

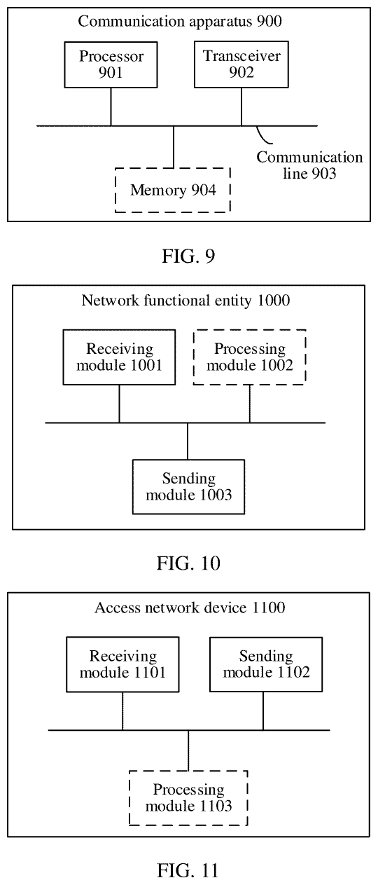

FIG. 9 is a schematic composition diagram of a communication apparatus 900 according to an embodiment of this application. A terminal device, an access network device, or a network functional entity in this embodiment of this application may use a structure shown in FIG. 9, or include a component shown in FIG. 9.

As shown in FIG. 9, the communication apparatus 900 includes a processor 901, a transceiver 902, and a communication line 903. Further, the communication apparatus 900 may further include a memory 904. The processor 901, the memory 904, and the transceiver 902 may be connected through the communication line 903.

The processor 901 is a central processing unit (CPU), a general-purpose processor, a network processor (NP), a digital signal processor (DSP), a microprocessor, a microcontroller, a programmable logic device (PLD), or any combination thereof. The processor 901 may alternatively be another apparatus that has a processing function, for example, a circuit, a component, or a software module. This is not limited.

The transceiver 902 is configured to communicate with another device or another communication network. The another communication network may be an Ethernet, a radio access network (RAN), a wireless local area network (WLAN), or the like. The transceiver 902 may be a module, a circuit, a transceiver, or any apparatus that can implement communication.

The communication line 903 is configured to transmit information between components included in the communication apparatus 900.

The memory 904 is configured to store instructions and/or data. The instructions may be a computer program.

The memory 904 may be a read-only memory (ROM) or another type of static storage device that can store static information and/or instructions, may be a random access memory (RAM) or another type of dynamic storage device that can store information and/or instructions, or may be an electrically erasable programmable read-only memory (EEPROM), a compact disc read-only memory (CD-ROM) or another compact disc storage, an optical disc storage (including a compact disc, a laser disc, an optical disc, a digital universal disc, a Blu-ray disc, and the like), a magnetic disk storage medium, or another magnetic storage device, or the like. This is not limited.

It should be noted that the memory 904 may exist independently of the processor 901, or may be integrated with the processor 901. The memory 904 may be configured to store instructions, program code, data, or the like. The memory 904 may be located inside the communication apparatus 900, or may be located outside the communication apparatus 900. This is not limited. The processor 901 is configured to execute the instructions stored in the memory 904, to implement a communication method provided in the following embodiments of this application.

In an example, the processor 901 may include one or more CPUs, for example, may include a CPU 0 and a CPU 1.

In an optional implementation, the communication apparatus 900 includes a plurality of processors.

In an optional implementation, the communication apparatus 900 further includes an output device and an input device. For example, the input device is a device, such as a keyboard, a mouse, a microphone, or a joystick, and the output device is device, such as a display or a speaker.

It should be noted that the communication apparatus 900 may be a desktop computer, a portable computer, a network server, a mobile phone, a tablet computer, a wireless terminal, an embedded device, a chip system, or a device having a structure similar to that in FIG. 9. In addition, a composition structure shown in FIG. 9 does not constitute a limitation on the communication apparatus. In addition to the components shown in FIG. 9, the communication apparatus may include more or fewer components than those shown in the figure, have a combination of some components, or have a different component arrangement.

If the structure shown in FIG. 9 is used for the terminal device in the foregoing embodiments of this application, after executing the program code in the memory 904, the processor 901 may implement operations implemented by the terminal device in the embodiment shown in any one of FIG. 2 to FIG. 8.

In an example, the transceiver 902 may be configured to perform S228, S229, S230, S250, or a similar operation in another embodiment, and the processor 901 may be configured to perform S240 or an operation with a similar function in another embodiment.

For example, the transceiver 902 may be configured to receive second configuration information of a perception task from an access network device. The second configuration information includes second area range information. The second area range information indicates to execute the perception task within a second area range. The processor 901 may be configured to execute the perception task based on the second configuration information of the perception task. The transceiver 902 may be further configured to send a perception result to the access network device.

Optionally, the transceiver 902 may be further configured to receive a paging message from the access network device. The processor 901 may be further configured to establish an RRC connection to the access network device.

Optionally, the transceiver 902 may be further configured to receive a paging message from a core network functional device. The processor 901 may be further configured to establish an RRC connection to the access network device.

If the structure shown in FIG. 9 is used for the access network device in the foregoing embodiments of this application, after executing the program code in the memory 904, the processor 901 may implement operations implemented by the access network device in the embodiment shown in any one of FIG. 2 to FIG. 8.

In an example, the transceiver 902 may be configured to perform S220, S228, S229, S230, S250, S260, or an operation with a similar function in another embodiment, and the processor 901 may be configured to perform S405 or an operation with a similar function in another embodiment.

For example, the transceiver 902 may be configured to receive first configuration information of a perception task from a core network functional entity. The first configuration information includes an identifier of a communication device and second area range information. The second area range information indicates to execute the perception task within a second area range. The transceiver 902 may be further configured to send second configuration information of the perception task to a terminal device based on the identifier of the communication device. The second configuration information includes the second area range information.

Optionally, the processor 901 may be configured to determine whether the terminal device is in a connected mode. When the terminal device is in a non-connected mode, the transceiver 902 may be further configured to send a paging message to the terminal device and establish an RRC connection to the terminal device.

Optionally, the processor 901 may be further configured to perform terminal device-level division on the perception task.

Optionally, the transceiver 902 may be further configured to receive a perception result from the terminal device and send the perception result to the core network functional entity.

Optionally, the processor 901 may be further configured to perform validity authentication on the perception task.

If the structure shown in FIG. 9 is used for the network functional entity in the foregoing embodiments of this application, after executing the program code in the memory 904, the processor 901 may implement operations implemented by the network functional entity in the embodiment shown in FIG. 2 or FIG. 3.

In an example, the transceiver 902 may be configured to perform S210, S220, S260, S270, S406, or another operation with a similar function in another embodiment, and the processor 901 may be configured to perform S406, S403, S405, S504, S603, or another operation with a similar function in another embodiment.

For example, the transceiver 902 may be configured to receive request information of a perception task from a task trigger source. The request information includes first area range information. The first area range information indicates to execute the perception task within a first area range. The transceiver 902 may be further configured to send first configuration information of the perception task to an access network device. The first configuration information includes an identifier of a communication device and second area range information. The second area range information indicates to execute the perception task within a second area range. The second area range is a subset of the first area range.

Optionally, the processor 901 may be configured to determine whether a terminal device is in a connected mode. When the terminal device is in a non-connected mode, the transceiver 902 may be further configured to send a paging message to the terminal device and establish an RRC connection to the terminal device.

Optionally, the processor 901 may be further configured to perform terminal device-level division on the perception task.

Optionally, the transceiver 902 may be further configured to receive a perception result from the terminal device and send the perception result to the core network functional entity.

Optionally, the processor 901 may be further configured to perform validity authentication on the perception task.

FIG. 9 may be understood as a structural description of the terminal device, the access network device, or the network functional entity from a perspective of hardware. In this application, the network functional entity is further divided into modules from a perspective of logical function division.

As shown in FIG. 10, a network functional entity 1000 may include all or a part of the following modules: a receiving module 1001, a processing module 1002, and a sending module 1003. These modules provide a receiving function, a validity verification function, a task division function, and a sending function.

For example, the network functional entity may be configured to implement an operation implemented by the network functional entity in the embodiment shown in FIG. 2 or FIG. 3. For another example, the network functional entity may be configured to implement operations implemented by the first network functional entity in the embodiment shown in any one of FIG. 4A and FIG. 4B to FIG. 8. For another example, the network functional entity may be configured to implement operations implemented by the second network functional entity in the embodiment shown in any one of FIG. 4A and FIG. 4B to FIG. 8.

In an example, the receiving module may be configured to perform S210, S260, or a similar operation in another embodiment, the sending module may be configured to perform S220, S270, S406, or an operation with a similar function in another embodiment, and the processing module may be configured to perform S406, S403, S405, S504, S603, or an operation with a similar function in another embodiment.

For example, the receiving module 1001 may be configured to receive request information of a perception task from a task trigger source. The request information includes first area range information. The first area range information indicates to execute the perception task within a first area range. The sending module 1003 may be configured to send first configuration information of the perception task to an access network device. The first configuration information includes an identifier of a communication device and second area range information. The second area range information indicates to execute the perception task within a second area range. The second area range is a subset of the first area range.

Optionally, the processing module 1002 may be configured to determine whether a terminal device is in a connected mode. When the terminal device is in a non-connected mode, the sending module 1003 may be further configured to send a paging message to the terminal device and establish an RRC connection to the terminal device.

Optionally, the processing module 1002 may be further configured to perform terminal device-level division on the perception task.

Optionally, the receiving module 1001 may be further configured to receive a perception result from the terminal device. The sending module 1003 may be configured to send the perception result to a core network functional entity.

Optionally, the processing module 1002 may be further configured to perform validity authentication on the perception task.

As shown in FIG. 11, an access network device 1100 may include a receiving module 1101 and a sending module 1102. Optionally, the access network device 1100 may further include a processing module 1103. These modules are configured to implement a receiving function, a sending function, and a task division function.

For example, the access network device 1100 may be configured to implement an operation implemented by the access network device in the embodiment shown in any one of FIG. 2 to FIG. 8.

In an example, the receiving module may be configured to perform S220, S250, or an operation with a similar function in another embodiment. The sending module may be configured to perform S260, S228, S229, S230, or an operation with a similar function in another embodiment.

The processing module may be configured to perform S405 or an operation with a similar function in another embodiment.

For example, the receiving module 1101 may be configured to receive first configuration information of a perception task from a core network functional entity. The first configuration information includes an identifier of a communication device and second area range information. The second area range information indicates to execute the perception task within a second area range. The sending module 1102 may be further configured to send second configuration information of the perception task to a terminal device based on the identifier of the communication device. The second configuration information includes the second area range information.

Optionally, the processing module 1103 may be configured to determine whether the terminal device is in a connected mode. When the terminal device is in a non-connected mode, the sending module 1102 may be further configured to send a paging message to the terminal device and establish an RRC connection to the terminal device.

Optionally, the processing module 1103 may be further configured to perform terminal device-level division on the perception task.

Optionally, the receiving module 1101 may be further configured to receive a perception result from the terminal device. The sending module 1102 may be further configured to send the perception result to the core network functional entity.

Optionally, the processing module 1103 may be further configured to perform validity authentication on the perception task.

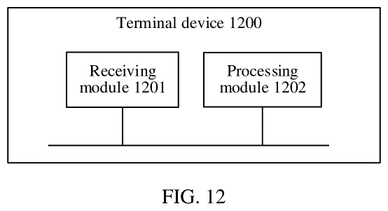

As shown in FIG. 12, a terminal device 1200 may include a receiving module 1201 and a processing module 1202. These modules are configured to implement a receiving function and a task execution function. Optionally, the terminal device 1200 may further include a sending module, configured to implement a sending function.

For example, the terminal device 1200 may be configured to implement an operation implemented by the terminal device in the embodiment shown in any one of FIG. 2 to FIG. 8.

The receiving module 1201 may be configured to perform S228, S229, S230, or an operation with a similar function in another embodiment. The processing module 1202 may be configured to perform S240 or an operation with a similar function in another embodiment. The sending module may be configured to perform S250 or an operation with a similar function in another embodiment.

For example, the receiving module 1201 may be configured to receive second configuration information of a perception task from an access network device. The second configuration information includes second area range information. The second area range information indicates to execute the perception task within a second area range. The processing module 1202 may be configured to execute the perception task based on the second configuration information of the perception task. The sending module may be configured to send a perception result to the access network device.

Optionally, the receiving module may be further configured to receive a paging message from the access network device. The processing module 1202 may be further configured to establish an RRC connection to the access network device.

Optionally, the receiving module 1201 may be further configured to receive a paging message from a core network functional device. The processing module 1202 may be further configured to establish an RRC connection to the access network device.

Based on the foregoing descriptions of the implementations, a person skilled in the art may clearly understand that for the purpose of convenient and brief descriptions, division into the foregoing functional modules is merely used as an example for description. During actual application, the foregoing functions can be allocated to different functional modules for implementation based on a requirement, that is, an inner structure of an apparatus is divided into different functional modules to implement all or a part of the functions described above.

In the several embodiments provided in this application, it should be understood that the disclosed apparatus and method may be implemented in other manners. For example, the described apparatus embodiments are merely examples. For example, division of the modules or units is merely logical function division, and may be other division during actual implementation. For example, a plurality of units or components may be combined or may be integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. A part or all of the units may be selected based on actual requirements to achieve the objectives of the solutions of embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit.

All or a part of the foregoing embodiments may be implemented by software, hardware, firmware, or any combination thereof. When a software program is used to implement embodiments, all or a part of embodiments may be implemented in a form of a computer program product. The computer program product includes one or more computer instructions. When the computer program instructions are loaded and executed on a computer, all or a part of the procedures or functions according to embodiments of this application are generated. The computer may be a general-purpose computer, a dedicated computer, a computer network, or any other programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center that integrates one or more usable media. The usable medium may be a magnetic medium (for example, a floppy disk, a hard disk, or a magnetic tape), an optical medium (for example, a DVD), a semiconductor medium (for example, a solid state disk (SSD)), or the like. In embodiments of this application, the computer may include the apparatus described above.

Although this application is described with reference to embodiments, in a process of implementing this application that claims protection, a person skilled in the art may understand and implement another variation of the disclosed embodiments by viewing the accompanying drawings, the disclosed content, and the appended claims. In the claims, the term “comprising” does not exclude another component or another step, and “a” or “one” does not exclude a case of plurality. A single processor or another unit may implement several functions enumerated in the claims. Some measures are recorded in dependent claims that are different from each other, but this does not indicate that these measures cannot be combined to produce a better effect.

Although this application is described with reference to specific features and embodiments thereof, it is clear that various modifications and combinations may be made to the application without departing from the spirit and scope of this application. Correspondingly, the specification and the accompanying drawings are merely examples of descriptions of this application defined by the appended claims, and are considered as any or all modifications, variations, combinations, or equivalents that cover the scope of this application. Clearly, a person skilled in the art can make various modifications and variations to this application without departing from the spirit and scope of this application. In this way, this application is intended to cover these modifications and variations of this application provided that they fall within the scope of the claims of this application and their equivalent technologies.

1. A communication method, comprising:
receiving, by a core network functional entity, request information of a perception task from a task trigger source, wherein the request information comprises first area range information, and the first area range information indicates to execute the perception task within a first area range; and
sending, by the core network functional entity, first configuration information of the perception task to an access network device, wherein the first configuration information comprises an identifier of a communication device and second area range information, the second area range information indicates to execute the perception task within a second area range, and the second area range is a subset of the first area range.

2. The communication method according to claim 1, wherein the communication device comprises the access network device.

3. The communication method according to claim 1, wherein
the communication device comprises a terminal device,
the method further comprises:
obtaining, by the core network functional entity, at least one of mobility information, task subscription information, or perception capability information of the terminal device, and
the sending, by the core network functional entity, the first configuration information of the perception task to the access network device comprises:
sending, by the core network functional entity, an identifier of the terminal device and the second area range information to the access network device based on the obtained information.

4. The communication method according to claim 3, further comprising:
determining, by the core network functional entity, whether the terminal device is in an idle mode; and
in response to determining the terminal device is in the idle mode, sending, by the core network functional entity, a paging message to the terminal device.

5. The communication method according to claim 1, wherein the request information further comprises a type of the perception task, and the type of the perception task comprises one or more of theterahertz imaging perception, camera visual perception, channel state information perception, or location perception.

6. The communication method according to claim 1, wherein the first configuration information further comprises one or more of a measurement period of the perception task, a reporting trigger mode of a perception result of the perception task, a data reporting mode of the perception result of the perception task, a reporting interval of the perception result of the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

7. A communication apparatus, comprising:
a processor; and
a memory having instructions stored thereon that, when executed by the processor, cause the communication apparatus to:
receive request information of a perception task from a task trigger source, wherein the request information comprises first area range information, and the first area range information indicates to execute the perception task within a first area range; and
send first configuration information of the perception task to an access network device, wherein the first configuration information comprises an identifier of a communication device and second area range information, the second area range information indicates to execute the perception task within a second area range, and the second area range is a subset of the first area range.

8. The communication apparatus according to claim 7, wherein the communication device comprises the access network device.

9. The communication apparatus according to claim 7, wherein the communication device comprises a terminal device, and the communication apparatus is further caused to:
obtain at least one of mobility information, task subscription information, or perception capability information of the terminal device; and
send an identifier of the terminal device and the second area range information to the access network device based on the obtained information.

10. The communication apparatus according to claim 9, wherein the communication apparatus is further caused to:
determine whether the terminal device is in an idle mode; and
in response to determining the terminal device is in the idle mode, send a paging message to the terminal device.

11. The communication apparatus according to claim 7, wherein the request information further comprises a type of the perception task, and the type of the perception task comprises one or more of terahertz imaging perception, camera visual perception, channel state information perception, or location perception.

12. The communication apparatus according to claim 7, wherein the first configuration information further comprises one or more of a measurement period of the perception task, a reporting trigger mode of a perception result of the perception task, a data reporting mode of the perception result of the perception task, a reporting interval of the perception result of the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

13. A non-transitory computer-readable storage medium having instructions stored thereon that, when executed by a processor, cause an apparatus to:
receive request information of a perception task from a task trigger source, wherein the request information comprises first area range information, and the first area range information indicates to execute the perception task within a first area range; and
send first configuration information of the perception task to an access network device, wherein the first configuration information comprises an identifier of a communication device and second area range information, the second area range information indicates to execute the perception task within a second area range, and the second area range is a subset of the first area range.

14. The non-transitory computer-readable storage medium according to claim 13, wherein the communication device comprises the access network device.

15. The non-transitory computer-readable storage medium according to claim 13, wherein the apparatus is further caused to:
obtain at least one of mobility information, task subscription information, or perception capability information of the terminal device; and
send an identifier of the terminal device and the second area range information to the access network device based on the obtained information.

16. The non-transitory computer-readable storage medium according to claim 15, wherein the apparatus is further caused to:
determine whether the terminal device is in an idle mode; and
in response to determining the terminal device is in the idle mode, send a paging message to the terminal device.

17. The non-transitory computer-readable storage medium according to claim 13, wherein the request information further comprises a type of the perception task, and the type of the perception task comprises one or more of terahertz imaging perception, camera visual perception, channel state information perception, or location perception.

18. The non-transitory computer-readable storage medium according to claim 13, wherein the first configuration information further comprises one or more of a measurement period of the perception task, a reporting trigger mode of a perception result of the perception task, a data reporting mode of the perception result of the perception task, a reporting interval of the perception result of the perception task, a quantity of reporting times of the perception result of the perception task, a reporting time length of the perception result of the perception task, a data reporting type of the perception result of the perception task, sensor information corresponding to the perception task, or data anonymization indication information of the perception result of the perception task.

19. The communication method according to claim 4, wherein the paging message carries a paging cause value, wherein the paging cause value indicates that the paging message is triggered by the perception task.

20. The communication apparatus according to claim 10, wherein the paging message carries a paging cause value, wherein the paging cause value indicates that the paging message is triggered by the perception task.
